(19) United States
(12) Patent Application Publication
(10) Pub. No.: US 2008/0171587 A1
(43) Pub. Date: Jul. 17, 2008

(54) Method for employing automatic optimum expected value play function in wagered games

(75) Inventor: Kathleen Nylund Jackson, Scituate, MA (US)

Correspondence Address: Mark A. Litman & Associates, P.A., York Business Center, Suite 205, 3209 West 76th St., Edina, MN, 55435, US

(73) Assignee: Precedent Gaming, Incorporated

(21) Appl. No.: 11/653,746

(22) Filed: Jan. 16, 2007

(51) Int. Cl. A63F 13/00

(52) U.S. Cl. 463/20

(57) ABSTRACT

A monitor screen is provided on which symbols may be provided for use in a slot-type wagering game or a video poker game. A predetermined set of available symbols or cards is provided for use in the symbol game. At any point in the game after a wager is placed by the player, a random spin or deal of a single symbol or plurality of symbols is shown. Based on the rules of the game and predetermined paytables, the symbol(s) are automatically evaluated by the machine or processor to determine which symbol selection, arrangement, order and/or placement would provide the player with the optimum expected value (Optimum EV). Optimum EV is described as the highest average expected payoff in the long run. It is generally calculated by adding up the sum of the probabilities of each event times the payoff for each event. The selection, arrangement, order and/or placement as determined by the Optimum EV is executed as a play function and the game continues according to the predetermined rules. After a final result in the game is achieved, any wins or losses are determined according to a predetermined paytable. An additional side bet may or may not be required to employ the Optimum EV play function.

### BACKGROUND OF THE INVENTION

1. Field of the Invention

The present invention relates to an electronic poker game or slot symbol game suitable for use in casinos and other gaming enterprises. The invention further relates to video gaming play that provides a random deal (play or spin) of symbols from which a symbol selection, arrangement, order and/or placement is determined by the mathematically optimum expected value in relation to the rules of the game and predetermined paytables. Awards are based upon final outcomes of the final symbol selection, arrangement, order and/or placement according to a predetermined paytable.

2. Background of the Art

Electronic casino games, whether video poker or slot games, have grown exponentially in numbers in the last twenty years, as have the revenues generated by such machine games. It is estimated that more than three fourths of any casino's revenue is now provided by machine games as opposed to table games.

The casino patron usually gravitates to either table games or machine games due to the very nature of each genre. The table player can be drawn by the camaraderie of group interaction and the typically lower house advantage games with less dramatic win/loss swings. Odds of approximately 1-to-1 (within 1-2%) are common in casino table games, and can provide the player with more frequent wins and a slower depreciation of assets. By way of contrast, the machine player is more likely to enjoy solitary play. The solitary player also is motivated to play games that may have larger house advantages but which can provide huge payouts, albeit with a higher degree of volatility. This higher volatility is due to the fact that to provide large or jackpot wins, the game must have many more results which are either a complete loss, a push or a win of less than the total wager. The machine player can become disheartened with a streak of these losing results. Additionally, in games that feature a multiple step game play, the initial spin or deal may appear to be both a losing event and a poor start, which can compound the player's frustration and lead to less time on the machine. There is often the perception that the machine game is “rigged” to provide an inordinate amount of these bad starts, especially after a player has had some initial winning results. Prior art has sought to address these issues, but there is still a need for new inventive game play that gives the player more positive expectations and a feeling that even poor starts can be turned into a win.

U.S. Pat. No. 6,855,054 (White) describes methods of playing games of chance and gaming devices and systems comprising a display of a plurality of symbols where at least one symbol may be interchanged (two way exchange) with another symbol of the plurality of symbols. After a combination of symbols initially is randomly generated and the initial results are displayed to a player, the player may have the opportunity to interchange at least one displayed symbol with another symbol in order to configure a more advantageous symbol arrangement.

U.S. Pat. No. 6,641,477 and 5,704,835 (Dietz, II) describe an electronic slot machine and method of use which allows a player to completely replace up to all of the initial symbols displayed after the first draw in order to create, improve or even lose a winning combination. If a suitable winning combination is not formed with the initial symbols, the player is given opportunities to select up to all of the symbol display boxes for replacement.

U.S. Pat. No. 6,422,940 (Walker) describes a gaming device that generates an initial hand of five cards. The first hand defines thirty-two draw strategies (each card held or not held), and at least one draw strategy is an optimum draw strategy having the maximum expected value of all draw strategies. The gaming device then selects a hand grouping that cannot result from the optimum draw strategy. For example, for an initial hand “10-clubs, 10-spades, 5-diamonds, 2-diamonds, 4-diamonds”, the hand grouping “Flush” cannot result from a draw strategy that results in holding two or more cards with different suits. The payout ratio of the selected hand grouping is increased by adding a bonus amount thereto. The gaming device thus provides an incentive for a player to select a suboptimum draw strategy, yet the expected value of the optimum strategy is unaffected by the increased payout.

U.S. Pat. No. 6,126,541 (Fuchs) describes a gaming machine that can display increased and/or best-possible win chances and/or instructions for determining them, which are available for the next game or could possibly be achieved in the next game.

U.S. Pat. No. 5,511,781 (Wood) describes a system that is adaptable to any game where a player sequentially receives a number of elements having identifying characteristics, with certain combinations of elements defined to be winning combinations. After all or part of an initial set of elements is obtained, the system offers the player an award to stop play prior to receiving a final set of elements. The amount of the offer is preferably based, at least in part, upon the probabilities of obtaining a winning combination using the initial set of elements received by the player. In accepting the “stop play” offer, the play of the game may cease, with the player forfeiting the right to win an award based on the final winning combinations, or, in an alternate embodiment, play can continue with an award, if any, based upon a modified pay schedule. In one embodiment, a standard video poker game is modified whereby upon receiving the initial set of five cards, an expected (winning) value for those cards is calculated based upon a summation of the awards and probabilities associated with every available discard and draw combination. Prior to permitting discards and further draws, an offer is made to the player based upon this calculated value. If the award is accepted, several playing options can be made available, such as terminating play, continuing play to show the optimum strategy and the result that would have been thereby obtained, or continuing play using a modified award schedule.

United States Patent Application Number 20050079908 (Pacey) a gaming machine having an award-trading scheme and a method for conducting the award-trading scheme. The method includes receiving a wager to play the wagering base game and detecting a winning outcome to the wagering base game, and providing a first award option to a player of the wagering base game, where the first award option is displayed on a video display of the gaming machine. The method also includes precluding the player from receiving the winning credits and awarding the first award option to the player in response to the first award option being exercised by the player. The method further includes providing a second award option in response to the first award option not being exercised by the player. The first and second award options can include credits and free game play, to name a few.

United States Patent Application Number 20050059451 (Shackleford) describes a method, apparatus, and computer readable storage medium for implementing improvements in video poker games. A second draw can be offered to the player, allowing the player an additional chance to improve the player's hand. The second draw can be always offered or triggered upon predefined conditions.

United States Patent Application Number 20040242312 (Gomez) describes a wagering game that includes a plurality of symbols displayed in an array. The plurality of symbols is evaluated to determine a change to one of the symbols that will yield one of a plurality of predefined winning combinations of symbols. The one of the symbols is changed to another of the symbols to form the winning combination, and an award is awarded for the winning combination.

United States Patent Application Number 20040063483 (Wolf) describes a gaming device which displays to a player the mathematically optimal or best way to play a game with minimal processing and memory usage. The game can be any version of video poker, slot game with a hold-a-reel feature, blackjack or other game with a finite number of outcomes after requiring the player to make choice of how to proceed. The present invention also includes the methods of how to make and use the auto-hold tables.

United States Patent Application Number 20030176215 (Palmer) provides a processor controlled gaming device having a display device in communication with the processor. When the display device receives an input from the player, gaming device 10 randomly generates an outcome, the display device displays an event having the outcome and gaming device 10 provides the player with a payout in association with the outcome and the selected input. The inputs have paytables that vary in range. One input has a large, risky payout range with big and small payouts. One input has a small, conservative payout range with intermediate payouts. Other inputs have ranges that fall in between the risky and conservative ranges. Each of the ranges has the same overall expected value, so that gaming device 10 does not favor the player's choice of a risky or conservative input.

United States Patent Application Number 20030153382 (Vancura) describes a method for playing a slot machine in which strategic information can be provided to the player for favorable play. The player applies strategy based on information available on the pay table and/or rules of play to select at least one symbol.

United States Patent Application Number 20030092475 (Fox) describes a method of playing a card game wherein a first hand of cards is dealt, a mathematical value for the first hand of cards is determined, additional hands of cards are dealt, each additional hand having a mathematical value about equal to the mathematical value of the first hand, and crediting is applied in accordance with a pay table associated with the value of each hand played.

United States Patent Application Number 20020125641 (Moody) describes a video poker machine that provides an auto hold feature that can be selectively turned on or off by the player. When the player uses the auto hold feature, the player plays against a first pay table which has a first theoretical game return. If the player does not use the auto hold feature, then the player plays against a second pay table with a slighter better theoretical game return than the first pay table.

It is an objective of this invention to provide players with new and enticing gameplay features that will stimulate player interest and increase time on the machine. In particular, this invention seeks to provide the player with a positive or positive-appearing game play function after a random spin or deal that will heighten the player's expectations and boost confidence in the likelihood of a winning result.

### SUMMARY OF THE INVENTION

Information is provided to a player, as on a wagering device having at least one monitor screen on which screen symbols may be provided for use in a slot-type wagering game or a video poker game. In a slot game played on the wagering device, a randomly provided set of symbols from a set of available symbols is provided for use in the symbol game. Upon a wager placed by the player, a random spin or deal of at least a single symbol or more generally a plurality of symbols is shown. Based on the rules of the game and predetermined paytables, the symbol(s) are automatically evaluated by a processor in the wagering device (the machine) or an associated distal or proximal processor to determine a potential course of conduct for further play on the device with the initial symbols provided. For example, the processor may determine the optimum play based on expected value, and automatically place the symbol(s) in the most advantageous position(s). Alternately, the processor may determine for and provide information to the player as to which symbol selection (for retaining or discarding) and/or placement would provide the player with the optimum expected value (Optimum EV, or the mathematically optimum probability of return on the wager for at least one and preferably more than one and up to all combinations of symbols for retention and replacement). The device and system may also visually display the mathematic probabilities, reward/risk and probabilities of the at least one to all retention/discard operations.

Optimum EV is described as the highest average expected payoff in the long run. It may be calculated at least by the common mathematic principles and steps of adding up the sum of the probabilities of each event times the payoff for each event. As a non-limiting example, consider the following hand of draw poker: 10♡, Jack♡, Ace♡, 2♡, and 2 [symbol] , 10 of Hearts, Jack of Hearts, Ace of Hearts, 2 of Hearts and 2 of Clubs. In a draw poker game on a $1.00 machine and wagering 1 credit per hand, holding the pair of 2s statistically would turn into 3-of-a-Kind once in every 8.7 times, and into 2 pair every 6.3 times. They statistically would convert into a Full House every 98 times, and into 4-of-a-Kind every 360 times. Based on the paytable below, multiplying every possibility times the payout, then dividing the result by the total possibilities, the value of holding just the 2s results in an expected value of approximately $0.79 in the long run.

### Sample Paytable

| RANK | Payout |
|---|---|
| Pair of Jacks or Better | 1 |
| 2 Pairs | 2 |
| 3-of-a-Kind | 3 |
| Straight | 4 |
| Flush | 5 |
| Full House | 6 |
| 4-of-a-Kind | 25 |
| Straight Flush | 50 |
| Royal Flush | 1,000 |

Using the same poker hand and paytable above, holding all 4 Hearts would convert to a Flush 9 times, and a pair of Jacks or higher 6 times, for an expected value of $1.09 in the long run. Holding only the Ten of Hearts, the Jack of Hearts and the Ace of Hearts, and considering all the winning combinations (including the most-valuable Royal Flush), this selection would be worth $1.40 in the long run. The highest expected value for this same poker hand is thus $1.40, and so the Optimum expected value dictates holding the 3 high Hearts. This result is not intuitively obvious to most players, and the provision of the probabilities is a significant value to a player attempting to play the best odds.

Continuing the description of exemplary game play above, the result of said symbol selection, retention, discard and/or placement of individual or groups of symbols may be a final result, or may be a partial result. For example, upon rearrangement and/or replacement of interchange of symbols, there may be an additional discard and replacement step, with certain symbols retained and new symbols provided for the symbol positions where symbols were not retained. If the result is final, the game may end, with the result being compared to a predetermined paytable and the player being awarded a prize if applicable as a resolution of the individual game play. If the result of the symbol selection and/or placement is a partial result, additional game play may be provided according to the predetermined rules of play until a final result is achieved. This final result is then compared to the predetermined paytable and any wins are paid to the player. An additional side bet may or may not be required to employ the Optimum EV play function. The game is also applicable in a situation where the player's hand is competing against a dealer's hand or another player's hand, with at least the player's hand being provided with the unique rearrangement, discard and/or replacement of symbols.

For an example of use in a video poker game application, consider a format wherein the player makes a first wager to play an underlying draw or stud poker game consisting of at least one hand of poker (assumed here to be against a paytable, but also possibly against another hand that is in active play in the game, as a dealer's hand or another player's hand). An additional or side bet may be required to utilize the Optimum EV play option. That is, a normal Poker game is played, except where a side bet or activation bet is made to allow the player to be provided with and execute the Optimum EV play option. A predetermined or random number of initial cards are randomly dealt from a standard deck or decks of 52 cards (or, by way of non-limiting example, up to 54 cards including jokers). The cards are evaluated by the processor or machine, and the Optimum EV is calculated for selection and placement of predetermined number(s) of said initial cards into the wagered hand(s).

The Optimum EV is based on the rules of the game, mathematic probabilities and predetermined paytables. The initial cards are then selected and/or placed (by the player or by authorized/enabled automatic action of the device through its processor) according to the Optimum EV, and may fill each wagered hand in full, or may form partial hands. Play continues according to the rules of the game, which may include immediately comparing the full hand (and in certain games also intermediate or partial hands, as in a game in which an initial hand of 3 cards plays Three Card Poker® games, the 5-card hand plays a five card poker game and a final 7-card hand plays a best 5 of 7 poker game, each against the same or different pay tables) or hands against a predetermined paytable or permitting a draw step before comparison, or completing the hands or hands by randomly filling any partial hands with cards from a depleted deck or a complete separate deck, with or without permitting a draw step. The fill step may be repeated a second time with the same fill cards that are shuffled and then replaced.

Those trained in the art will appreciate that these play options are exemplary and are not intended to dictate an exclusive method of play, nor limit or restrict specific gameplay. This invention discloses that the determination of Optimum EV and subsequent use thereof is an integral function of the gameplay. The Optimum EV play function may occur after any random event, deal or spin and may occur at any time during the predetermined specified slot symbol or video poker gameplay.

### BRIEF DESCRIPTION OF THE FIGURES

FIG. 1 shows a monitor screen of a slot machine with the random spin of 5 initial symbols.

FIG. 2 shows the same game at a later stage.

FIG. 3 shows the same game at a final stage.

FIG. 4 shows a monitor screen of a video poker machine with areas for three wagered hands and the initial play of a poker game comprising the random deal of a six cards.

FIG. 5 shows the same poker game at a later stage.

FIG. 6 shows the same poker game at a later stage.

FIG. 7 shows the same poker game at a final stage.

### DETAILED DESCRIPTION OF THE INVENTION

A monitor screen is provided on which symbols may be provided for use in a slot-type wagering game or a video poker game. In a slot game, a predetermined set of available symbols is provided for use in the symbol game. The symbol game is preferably played in a 5-column×3-row format, displaying 15 symbols in symbol areas of the matrix (although more or fewer symbols may be used in matrices with more or fewer frames or symbol areas). In addition, the symbols or may or may not be displayed in frames or areas in a symmetrical array. Upon an initial wager by a player, a random plurality of initial symbols is preferably shown outside of the 5×3 matrix. The actual number of initial symbols may be predetermined, or may be random. An initial side bet may be required to receive at least a minimum plurality of initial symbols. The symbols are then evaluated by the processor or machine, and the optimum expected value (Optimum EV) is calculated for selection, arrangement, order and/or placement of a predetermined number of said initial symbols into the matrix. Optimum EV is described as the highest average expected payoff in the long run. It is generally calculated by adding up the sum of the probabilities of each event times the payoff for each event. There may be predetermined rules related to the selection and/or placement of the symbols; as examples, a specific number of symbols may be chosen for selection from a larger plurality of initial symbols, or only one symbol may be allowed to be placed in any one column. After the initial symbols are selected and placed according to the Optimum EV, additional symbols from the predetermined set of symbols are randomly placed to fill each area of the matrix. The game is evaluated for pays according to a predetermined pay table and any resultant wins are paid to the player.

In a video poker game, the player makes a wager per hand to play an underlying stud poker game consisting of at least two hands of poker. Initial cards are dealt, and cards are selected and automatically placed according to the Optimum EV for each hand or the totality of hands. An alternate method would provide the player with Optimum Expected Values as shown by a rate of expected return or percentage, and allow card selection, arrangement, order and/or placement by the player. If the hands are all complete, the game may be over and hands are evaluated against a predetermined paytable and any wins are paid. A draw step may be provided before the final evaluation for payouts. If the hands are only partially complete, fill cards from a depleted deck are provided to each hand and any win payouts are shown. The player may then choose to keep the any wins and end the game, or forfeit any wins and be provided with a shuffle and replacement of the fill cards. (An alternate method would allow the player to keep any wins and also be provided with the shuffle and replacement of the fill cards.) Any wins for this second configuration are paid.

By way of example, the player wagers 15 credits to play 3 concurrent hands of 5-card stud poker. Two cards×the number of hands are randomly dealt from a standard deck of 52 cards. The initial random deal of 6 cards is shown, preferably on the screen area outside of the hand grid areas. The cards are evaluated by the processor or machine, and the Optimum EV is calculated for placing sets of 2 cards into each of the 3 hands. The cards are placed accordingly, providing 3 partial stud hands. Each hand is then completed with 3 fill cards from the depleted original deck (52 cards minus the initial 6 cards, or 46 available cards), with no duplication of cards. In other words, all 15 cards in the total of 3 hands are different. Each hand is then evaluated against a predetermined paytable, and the payouts shown for each hand. The player is then instructed to either take any wins and end the game, or give up any wins for a second chance. (An alternate method would allow the player to take the first payouts as wins, and continue play with the second chance step.) The second chance feature allows for a shuffle of the same 9 fill cards, and then redeals the same 9 fill cards into the 3 original partial hands. A final evaluation is made, and any wins according to the same or altered paytable are awarded to the player.

Reference to the Figures will assist in further understanding of the practice of the present invention.

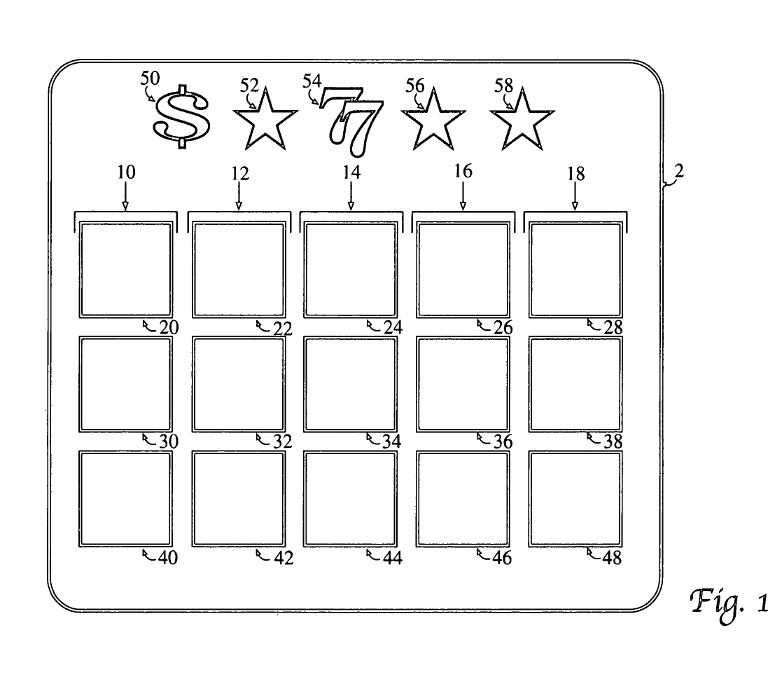

FIG. 1 shows a slot machine monitor screen 2 after the player has wagered to play a 9-line multiline video slot game. The multiline game grid is shown, incorporating five columns (10, 12, 14, 16, 18) by three rows of frames (20, 22, 24, 26, 28; 30, 32, 34, 36, 38; 40, 42, 44, 46, 48). A random display of five symbols (50, 52, 54, 56, 58) from a predetermined set is shown.

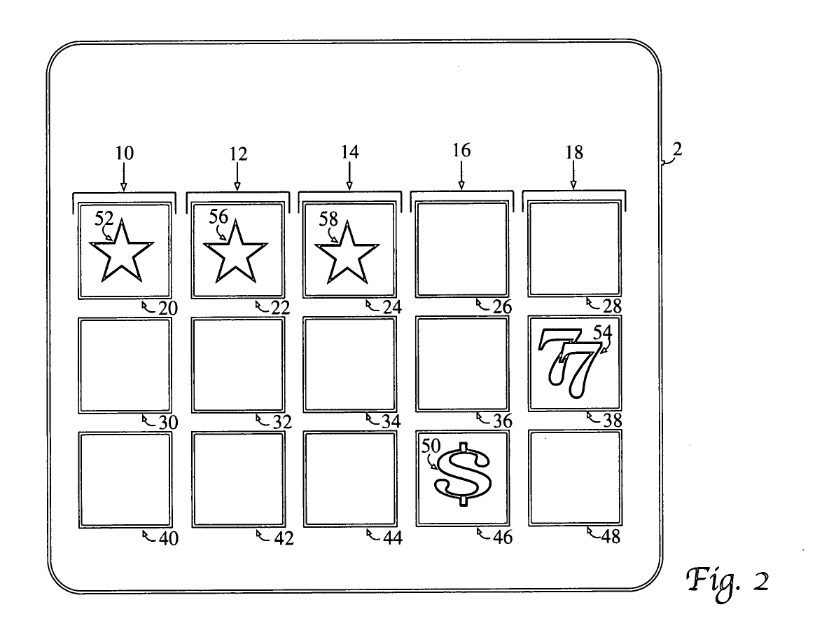

FIG. 2 refers to the game elements shown in FIG. 1 with the automatic Optimum EV placement of the five symbols (50, 52, 54, 56, 58). In this example, the star symbol (52, 56 or 58) is the highest-paying symbol, and game rules dictate that only one symbol (50, 52, 54, 56 or 58) may be placed in any one column (10, 12, 14, 16 or 18). The star symbol 52 is placed in frame 20, the star symbol 56 is placed in frame 22, the star symbol 58 is placed in frame 24, the dollar sign symbol 50 is placed in frame 46, and the double 7 symbol 54 is placed in frame 38.

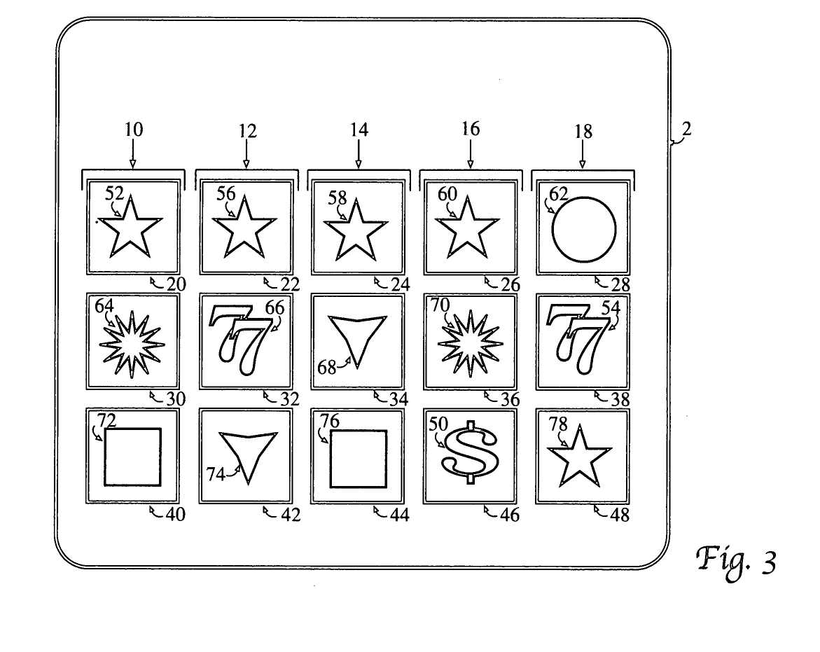

FIG. 3 refers to the game elements shown in FIG. 2 with the result of a random spin that fills the remaining frames (26, 28, 30, 32, 34, 36, 40, 42, 44, 48) respectively with symbols (60, 62, 64, 66, 68, 70, 72, 74, 76, 78) from the predetermined set. Frames 20, 22, 24 and 26 contain star symbols 52, 56, 58 and 60, and the player is awarded a Win for four same said star symbols.

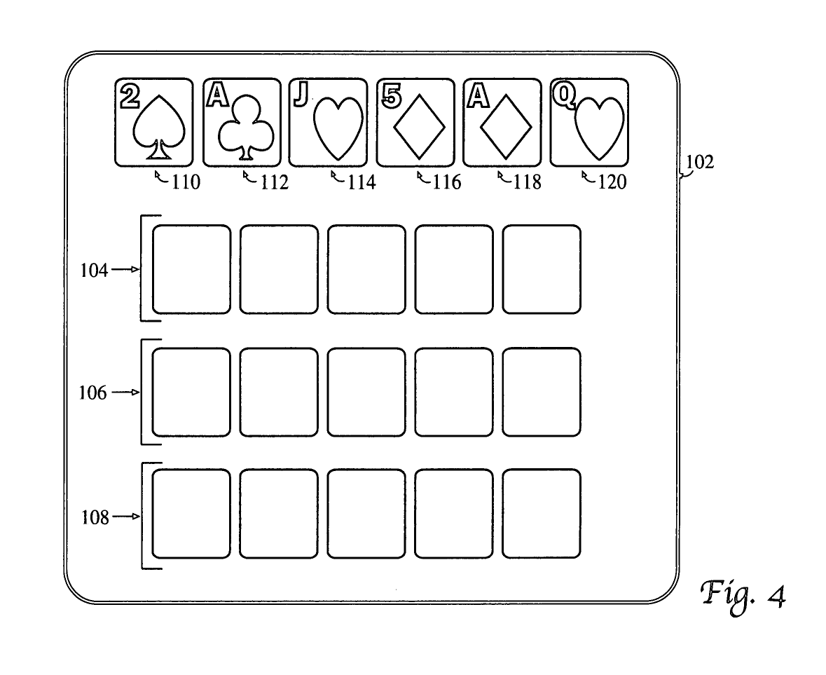

FIG. 4 shows a video poker machine monitor screen 102 after the player has wagered to play three 5-card hands of poker. Three grids (104, 106, 108) are shown, representing the three wagered hands. A random display of six different cards (110, 112, 114, 116, 118, 120) drawn from a single deck of 52 cards is shown.

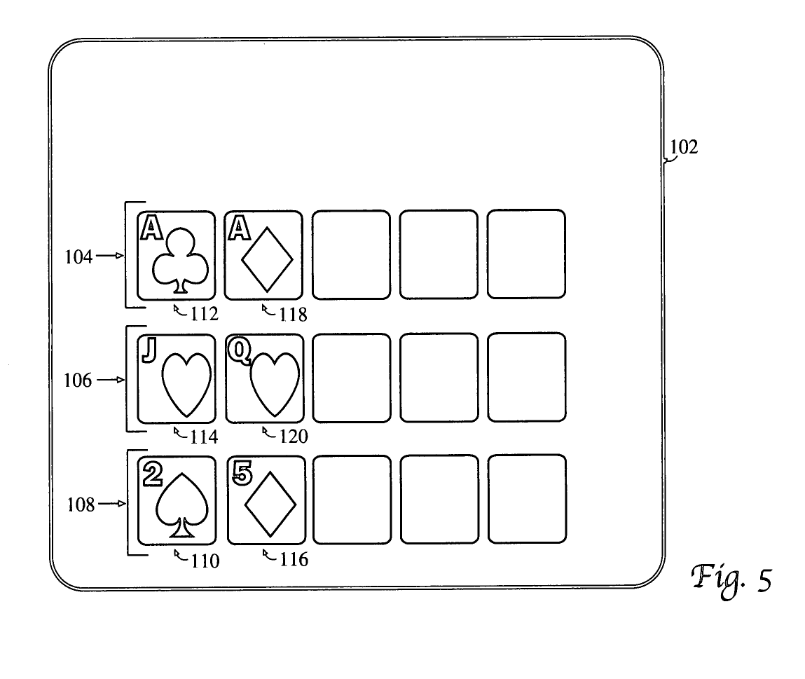

FIG. 5 refers to the game elements shown in FIG. 4 with the automatic Optimum EV placement of the six cards (110, 112, 114, 116, 118, 120). The Ace of Clubs 112 and the Ace of Diamonds 118 are placed into Hand 1 104. The Jack of Hearts 114 and the Queen of Hearts 120 are placed into Hand 2 106. The 2 of Spades 110 and the 5 of Diamonds 116 are placed into Hand 3 108. Alternate play may have the cards arranged by positioning the symbols at the direction of the player. This could be readily accomplished with a touch screen series of maneuvers, such as first touching a symbol (card) and then touching a desired screen frame. A keypad, mouse or joystick system might also be used.

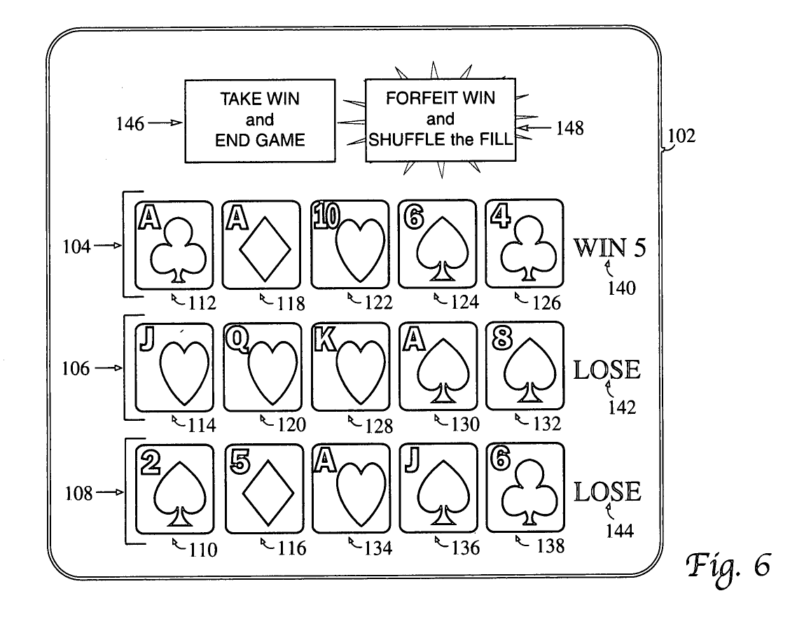

FIG. 6 refers to the game elements shown in FIG. 5 with three fill cards (122, 124, 126) being dealt into Hand 1 104, three fill cards (128, 130, 132) being dealt into Hand 2 106, and three fill cards (134, 136, 138) being dealt into Hand 3 108. All fill cards are dealt from the one depleted deck of 46 remaining cards, with all fill cards being different. Hand 1 104 shows a Win of 5 credits 140 for the Pair of Aces 112 and 118. Hand 2 106 shows a Loss 142, and Hand 3 108 shows a Loss 144. Two pop-up announcements are shown, directing the player to either Take Win and End Game 146, or Forfeit Win and Shuffle the Fill 148. Since the fill cards are already revealed, the player can make a calculated decision to determine which course of action to take. In this example, the player sees potential for a Pair of Jacks (114, 136), 3 or 4 Aces (112, 118, 130, 134), or a Royal Flush (114, 120, 122, 128, 134), and so decides to Forfeit the Win (5 credits), Shuffle the Fill 148 and play on.

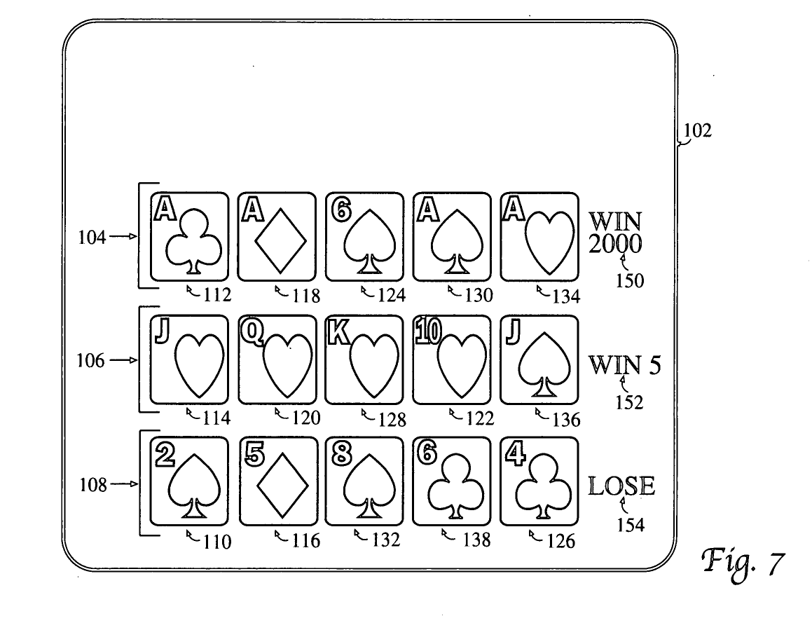

FIG. 7 refers to the game elements shown in FIG. 6 with the same nine fill cards shuffled and replaced into the original partial hands as shown in FIG. 5. Three fill cards (124, 130, 134) are redealt into Hand 1 104, three fill cards (128, 122, 136) are redealt into Hand 2 106, and three fill cards (132, 138, 126) are redealt into Hand 3 108. Hand 1 104 shows a Win of 2000 credits 150 for the 4 Aces (112, 118, 130, 134). Hand 2 106 shows a Win of 5 credits 152 for the Pair of Jacks (114, 136), and Hand 3 108 shows a Loss 154.

There is also a fundamental and basic game play consideration that is first described here. That play relates to automatic distribution of a first subset of cards among multiple hands to create optimal expected value hands from the first subset. This may be explained and described as follows:

The apparatus performs a method of playing a video game on a video game apparatus. The process includes a player making a wager that encompasses a multiple (at least two, up to 100 individual hands or even more) number of hands. The term hands used herein is a set of cards in a distinct set from which a ranked hand or the presence of an order or content of symbols is examined to determine if a winning combination, rank or event has occurred. Each hand usually must ultimately contain at least a set numbers of symbols (such as five in a five-card poker hand, at least three cards in Three-Card Poker® games, at least three symbols in a row of slot-type symbols, etc.

In the play according to the unique technology described herein, after making, for example, at least one wager on the video game for each hand of cards of multiple hands of cards to be played in the video game, a first set of symbols is provided comprising a predetermined (e.g., by way of an example, with five 5-card poker hands being played) number of first symbols (e.g., 10 symbols or playing cards with suit, rank, and/or suit and rank) for view. The processor (through a software program or algorithm hardwired into the system or a chip, ASIC or FPGA) evaluates the provided (10) symbols, and determines what combinations and distribution of symbols (preferably according to rule where no one of the multiple hands is completed, as with the 5 cards needed for a final hand) may be distributed among the hands (e.g., five hands in this example) to offer various or at least one optimal expected values. The various arrangements and distributions may be displayed or not with alphanumeric indications of the OEVs. The player may select from among the OEVs or the processor automatically selects an OEV and appropriately distributes the entire or less than entire first set of symbols among the multiple hands. A simplified and preferred version in this example would be for the processor to automatically distribute the first set of cards equally, the ten cards being distributed to the five hands as 2 cards each for the five hands according to the OEV. Other variations are within the scope of this disclosure than shown in the specific example, For example, again considering 5 hands, 4 cards may be in the first set and the cards may be distributed among the five hands as 1-1-1-1-0; 2-1-0-1-0; 2-0-0-2-0; 4-0-0-0-0; or in any other combination within the OEV developed by the processor for the first set of hands. Again considering 5 hands, 5 cards, 6 cards, 7 cards, 8 cards, 9 cards, 10 cards, 11 cards, up to even 25 or more cards may be in the first set, and the cards distributed according to the OEV. There is a practical, but not operational or functional limit to the number of cards, as where 52 cards are dealt for 5 hands, and the OEV would always be four royal flushes and four 9s. The pay scale would reflect the probabilities of high ranked hands according to the number of cards in the first set. A practical limit would, of course, be that the first set is less than all of the cards available in a virtual deck or decks.

In the play of a game according to this system, among the variations, would be where from the number of symbols in the first set, at least one symbol may be provided to each of the multiple hands and at least two symbols provided to one of the multiple hands. For example, with the five 5-card hand format, 6 cards may be provided, with one hand required to get at least two cards. The variations along this theme are apparent now that the context has been identified, and need not be further explained to exhaustion.

The processor determines a distribution of the first set of symbols among the multiple hands that provides an overall optimum expected value or at least optimal expected values to one or more hands. The processor may provide image data to be displayed on the monitor showing expected values of possible distributions of the first set of cards. The number of symbols in the first set may allow for at least two symbols to be placed into at least two of the multiple hands. The number of symbols may allow for at least two symbols to be placed into each of the multiple hands. The process may distribute the first set of cards among the multiple hands to maximize optimal expected value. The distribution process may distribute the first set of cards among the multiple hands to maximize optimal expected value. The distribution process may distribute the first set of cards among the multiple hands to maximize optimal expected value automatically or by player selection from among a multiple number of sets of OEVs, wherein some OEV will have lesser long term optimal expected values, but may be personally more attractive to a player because of greater short term probabilities. The processor may complete each of the multiple hands after the first set has been distributed with remainder cards from an original set of cards less the cards in the first set. The processor may complete each of the multiple hands after the first set has been distributed with remainder cards from an original deck of cards less the cards in the first set. The processor may complete each of the multiple hands after the first set has been distributed with remainder cards from an original deck of cards for each of the multiple hands less the cards in the first set provided to each multiple hand.

This format also has a unique potential for use in combination with Texas Hold'Em and Omaha poker variations, the hot poker games at this time. The system would allow for multiple hands to be played against a paytable, and automatically distribute the first set of cards among the multiple hands according to the OEV. As Texas Hold'Em requires 2 initial cards in the first partial hand, it fits cleanly into the play of the game, as would the four initial cards of Omaha, where it is likely that the first set might require a number fewer than the 4×5 cards needed for the five hands, so as to avoid too many potential straight flushes and a coincident reduction in the award amount for that hand and four-of-a-kind. Subsequent play may allow the player to fold any hands deemed to be less lucrative.

It is also possible that a player can wager on X number of hands and the game rules might require that a particular type of hand be discarded or prevented, such as a natural four-of-a-kind, where possible. In Texas Hold'Em, the better players or more technical players would appreciate viewing the percentage probabilities for each of the hands.

Although specific examples and specific images have been provided in this discussion, these specifics are intended to be only support for the generic concepts of the invention and are not intended to be absolute limits in the scope of the technology discussed.

What is claimed:

1. A method of playing a video game on a video game apparatus comprising:
providing to a player a gaming system comprising a monitor and a processor controlling the game and the monitor;
the player making at least one wager on the game;
providing with multiple frames to display symbols in multiple columns and multiple rows in which symbols are to be displayed in the play of the game;
providing a first set of symbols;
distributing at least one symbol of the first random set of symbols among the multiple frames; and
the game being played to conclusion with the at least one wager resolved.

2. The method of claim 1 wherein the first set of symbols comprises a number of symbols that is less than the number of multiple frames.

3. The method of claim 2 wherein an additional number of symbols is provided to the distributed number of the first set of symbols to more completely fill the multiple frames.

4. The method of claim 3 wherein the additional number of symbols completely fills the multiple frames in combination with the distributed number of the first set of symbols.

5. The method of claim 1 wherein the processor determines a value related to statistical approximation of value for a specific selection and/or order of symbols.

6. The method of claim 5 wherein the determined value determines an automatic play function of the processor.

7. The method of claim 3 wherein the game uses at least 3 rows and 3 columns to display symbols.

8. The method of claim 3 wherein the game uses at least 3 rows and 5 columns to display symbols.

9. A method of playing a video game on a video game apparatus comprising:
providing to a player a gaming system comprising a monitor and a processor controlling the game and the monitor;
the player making at least one wager on the video game for each hand of cards to be played in the video game, the video game allowing exercise of optional strategies in placing symbols during the play of the video game;
providing a first set of symbols comprising a predetermined number of playing cards forming initial card game hands of a predetermined initial number of playing cards in each hand of cards to be played in the video game;
distributing the first random set of symbols into each hand of cards to be played;
the processor identifying at least one expected value for an exercise of at least one said optional strategy in the play of the video game;
electing said at least one optional strategy in placing a symbol in the play of the video game; and
the game being played to at least a first conclusion with the at least one wager resolved.

10. The method of claim 9 wherein the processor identifies multiple options comprising placing one or more symbols and identifies and provides image data of expected values for at least one of the options.

11. The method of claim 10 wherein the processor provides image data for more than one of the options.

12. The method of claim 11 wherein one of the expected values comprises an optimum expected value.

13. The method of claim 12 wherein the processor, after identifying the optimum expected value and sending image data to the monitor to display the optimum expected value, enables selection of an option consistent with play of the optimum expected value.

14. The method of claim 13 wherein the player makes the selection of the option consistent with the optimum expected value.

15. The method of claim 13 wherein the processor automatically makes the selection of the option consistent with the optimum expected value.

16. The method of claim 9 wherein partial hands are displayed to assist in viewing at least one optional play, a partial hand consisting of playing cards suggested to be held being distinguished from cards suggested to be discarded.

17. The method of claim 16 wherein cards are distinguished by an event selected from the group consisting of different highlighting of cards or removal of cards suggested to be discarded.

18. The method of claim 9 wherein after the first conclusion, the player may elect to accept the resolution results for the first conclusion, return to the original first set of playing card symbols and replay the hand to a second conclusion, or discard one or more playing cards provided after exercise of the option to complete a second conclusion, and
resolving the wager on the basis of the second conclusion.

19. The method of claim 18 wherein the second conclusion uses a paytable different for a paytable used to resolve wagers on the first conclusion.

20. The method of claim 18 wherein, if the first conclusion comprises a winning resolution and the player forfeits the winning resolution to effect another replacement event of cards by discarding at least one card in the first conclusion, cards available for use in the replacement are provided as one of a) all cards remaining in a virtual set of cards inclusive of cards discarded from the first conclusion and b) all cards remaining in a virtual set of cards exclusive of cards discarded from the first conclusion.

21. A method of playing a video game on a video game apparatus comprising:
providing to a player a gaming system comprising a monitor and a processor controlling the game and the monitor;
the player making at least one wager on the video game for each hand of cards of multiple hands of cards to be played in the video game,
providing a first set of symbols comprising a number of symbols from which number of symbols at least one symbol may be provided to each of the multiple hands and at least two symbols provided to one of the multiple hands;
the processor determining a distribution of the first set of symbols among the multiple hands that provides an overall optimum expected value.

22. The process of claim 21 wherein the processor provides image data to be displayed on the monitor showing expected values of possible distributions of the first set of cards.

23. The process of claim 21 wherein the number of symbols allows for at least two symbols to be placed into at least two of the multiple hands.

24. The process of claim 21 wherein the number of symbols allows for at least two symbols to be placed into each of the multiple hands.

25. The process of claim 22 wherein the process distributes the first set of cards among the multiple hands to maximize optimal expected value.

26. The process of claim 23 wherein the process distributes the first set of cards among the multiple hands to maximize optimal expected value.

27. The process of claim 24 wherein the process distributes the first set of cards among the multiple hands to maximize optimal expected value.

28. The process of claim 26 wherein the processor completes each of the multiple hands after the first set has been distributed with remainder cards from an original set of cards less the cards in the first set.

29. The process of claim 26 wherein the processor completes each of the multiple hands after the first set has been distributed with remainder cards from an original deck of cards less the cards in the first set.

30. The process of claim 26 wherein the processor completes each of the multiple hands after the first set has been distributed with remainder cards from an original deck of cards for each of the multiple hands less the cards in the first set provided to each multiple hand.

31. A method of playing a video game on a video game apparatus comprising:
providing a first set of symbols comprising a predetermined number of playing cards forming initial card game hands of a predetermined initial number of playing cards in each hand of cards to be played in the video game;
distributing the first random set of symbols in each hand of cards to be played;
the processor identifying at least one expected value for an exercise of at least one said optional strategy in the play of the video game;
electing said at least one optional strategy in replacing a symbol in the play of the video game; and
the game being played to at least a first conclusion with the at least one wager resolved.
